(19) United States
(12) Patent Application Publication
(10) Pub. No.: US 2001/0036356 A1
(43) Pub. Date: Nov. 1, 2001

(54) Non-linear video editing system

(75) Inventors: Dale M. Weaver, Wheaton, IL (US); James J. Kuch, Wheaton, IL (US); Michel L. D'Arcy, Los Angeles, CA (US)

Correspondence Address: GATES & COOPER LLP, Howard Hughes Center, 6701 Center Drive West, Suite 1050, Los Angeles, CA, 90045, US

(73) Assignee: Autodesk, Inc.

(21) Appl. No.: 09/827,845

(22) Filed: Apr. 6, 2001

Related U.S. Application Data
(60) Provisional application No. 60/195,987, filed on Apr. 7, 2000.

(51) Int. Cl. H04N 5/93; G11B 27/00; G09G 5/00

(52) U.S. Cl. 386/52; 345/723

(57) ABSTRACT

A non-linear video editing system includes video editing software, executed by a computer system, for editing the digitized source material to create a sequence of one or more output frames. The video editing software displays one or more timelines on the monitor, wherein each timeline contains one or more tracks that separate, layer, and sequence sources, including video, audio, graphics and digital video effects sources. An operator places one or more events on one or more of the tracks in order to create the output frames.

### CROSS-REFERENCE TO RELATED APPLICATIONS

This application claims the benefit under 35 U.S.C. §119(e) of the co-pending and commonly assigned U.S. Provisional patent application Serial No. 60/195,897, filed on Apr. 7, 2000, by Dale Weaver, Jim Kuch, and Mike D'Arcy, entitled “NON-LINEAR VIDEO EDITING SYSTEM,” attorney's docket number 30566.113USP1, which application is incorporated by reference herein.

### BACKGROUND OF THE INVENTION

1. Field of the Invention

The present invention relates generally to computer-implemented audio-visual editing systems, and in particular, to non-linear video editing systems.

2. Description of the Related Art

Traditional video editing involves the copying of video material from source tape onto an edited tape. Sophisticated tape editing equipment is required and the process can be relatively time consuming, given that it is necessary to configure the equipment in order for the video material to be transferred correctly. Furthermore, editing of this type leads to image degradation.

In order to optimize expensive on-line editing equipment, off-line editing systems are known in which compressed video images are manipulated rapidly, by accessing image data in a substantially random fashion from magnetic disc storage devices. Given that it is not necessary to spool linearly through lengths of videotape in order to perform editing of this type, the editing process has generally become known as “non-linear editing”. Systems of this type generate edit decision lists (EDLs), such that the on-line editing process then consists of performing edits once in response to an edit decision list. However, the edit decision list itself could be created in a highly interactive environment, allowing many potential edits to be considered before a final list is produced.

The advantages of non-linear editing have been appreciated and high-end systems are known, such as those sold by the assignee of the present invention, in which full bandwidth signals are manipulated at full definition, without compression.

In a high-end system, it is possible to specify hardware requirements in order to provide a required level of functionality. Thus, systems tend to be designed to achieve a specified level of service and are tailored to suit an operator's particular demands. However, as the power of processing systems has increased, along with an increase in data storage volumes and access speeds, it has become possible to provide increasingly sophisticated on-line non-linear editing facilities. Consequently, there is a greater emphasis towards providing enhanced functionality in non-linear video editing systems.

### SUMMARY OF THE INVENTION

To address the requirements described above, the present invention discloses a non-linear video editing system. The non-linear video editing system includes video editing software, executed by a computer system, for editing the digitized source material to create a sequence of one or more output frames. The video editing software displays one or more timelines on the monitor, wherein each timeline contains one or more tracks that separate, layer, and sequence sources, including video, audio, graphics and digital video effects sources. An operator places one or more events on one or more of the tracks in order to create the output frames.

### BRIEF DESCRIPTION OF THE DRAWINGS

Referring now to the drawings in which like reference numbers represent corresponding parts throughout:

FIG. 1 shows a non-linear digital video-editing suite, having a processing system, monitors and recording equipment;

FIG. 2 details the processing system shown in FIG. 1 including a memory device for data storage;

FIG. 3 shows a typical Bin window as displayed on a video display unit according to the preferred embodiment of the present invention;

FIG. 4 shows a typical Timeline as displayed on a video display unit according to the preferred embodiment of the present invention;

FIGS. 5A and 5B illustrate a typical Sub-Timeline as displayed on a video display unit according to the preferred embodiment of the present invention;

FIG. 6 illustrates a multi-cam feature provided in the compositing architecture according to the preferred embodiment of the present invention;

FIGS. 7A and 7B illustrate a recursive method for serialization of compositing operations performed by the preferred embodiment of the present invention;

FIG. 8 illustrates a coarse grain invalidation method performed for cached hierarchically composited images according to the preferred embodiment of the present invention;

FIG. 9 illustrates a persistent and transient hashing method performed for hierarchical rendering instructions according to the preferred embodiment of the present invention; and

FIG. 10 illustrates a method for color space conversion and luma keying performed using hardware designed for resizing according to the preferred embodiment of the present invention.

### DETAILED DESCRIPTION OF THE PREFERRED EMBODIMENTS

In the following description, reference is made to the accompanying drawings which form a part hereof, and which is shown, by way of illustration, an embodiment of the present invention. It is understood that other embodiments may be utilized and structural changes may be made without departing from the scope of the present invention.

### Environment

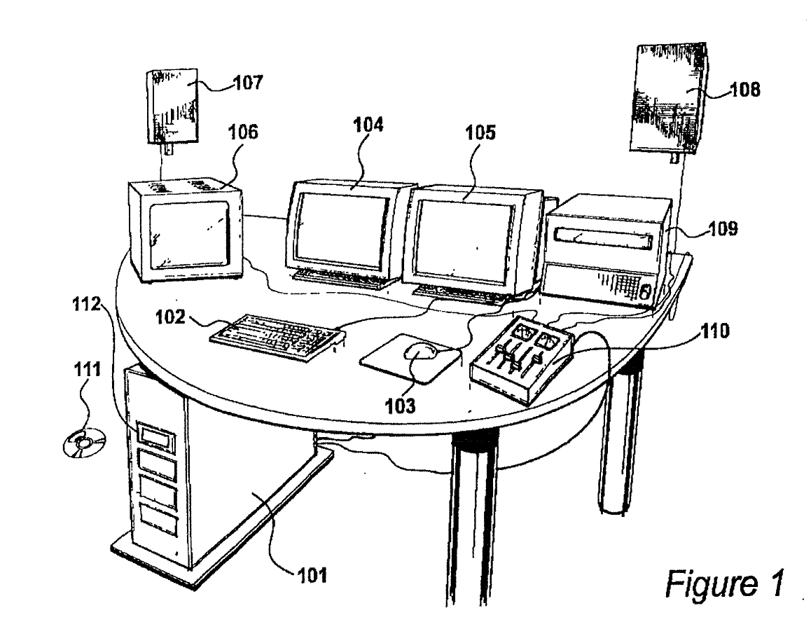

A non-linear digital video-editing suite is shown in FIG. 1 in which a processing system 101 receives manual input commands from a keyboard 102 and a mouse 103. A visual output interface is provided to an operator by means of a first visual display unit (VDU) 104 and second similar VDU 105. Broadcast-quality video images are supplied to a television type monitor 106 and stereo audio signals, in the form of a left audio signal and a right audio signal, are supplied to a left audio speaker 107 and to a right audio speaker 108 respectively.

Video source material is supplied to the processing system 101 from a high quality tape recorder 109 or other device, and edited material may be written back to the tape recorder 109 or other device. Recorded audio material is supplied from system 101 to an audio mixing console 110 from which independent signals may be supplied to the speakers 107 and 108, for monitoring audio at the suite, and for supplying audio signals for recording on the video tape recorder 109 or other device.

The processing system 101 typically operates under the control of an operating system and video editing software. In the preferred embodiment, the video editing software comprises the edit™ 6.0 software sold by Discreet, a division of Autodesk, Inc., which is the assignee of the present invention. The video editing software provides extensive real-time capabilities including scrubbing, playback, and teal-time motion effects. Operators can create key-frame-able real-time video, audio, and graphic transitions like dissolves and fades. These can be played simultaneously with real-time alpha-keyed graphics and real-time effects like embossed video, chromatic video, and color effects. The operator has the ability to view and edit the properties of media, as well as move timelines, bins and sources between jobs with a browser. More information on the video editing software can be found in “edit™ Version Six Operator's Guide,” Autodesk, Inc., January, 2001, which publication is incorporated by reference herein.

Generally, the operating system and video editing software comprise logic and/or data embodied in or readable from a device, media, or carrier, e.g., one or more fixed and/or removable data storage devices connected directly or indirectly to the processing system 101, one or mote remote devices coupled to the processing system 101 via data communications devices, etc. In this embodiment, the video editing software is represented by a CD-ROM 111 receivable within a CD ROM player 112.

Of course, those skilled in the art will recognize that the exemplary environment illustrated in FIG. 1 is not intended to limit the present invention. Indeed, those skilled in the art will recognize that other alternative environments may be used without departing from the scope of the present invention.

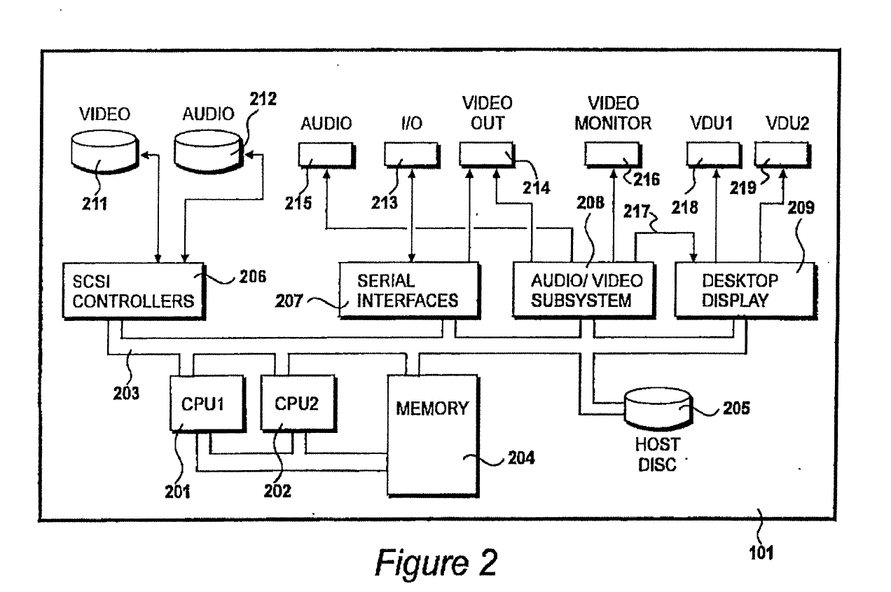

FIG. 2 further illustrates the components of the processing system 101, which in one embodiment is a dual-processor workstation. A first processing unit 201 and a second processing unit 202 are interfaced to a PCI bus 203. In the example shown, the processors 201 and 202 communicate directly with an internal memory 204 over a high bandwidth direct address and data bus, thereby avoiding the need to communicate over the PCI bus during processing except when other peripherals are being addressed. In addition, permanent data storage is provided by a host disc system 205, from which operating instructions for the processors may be loaded to memory 204, along with operator generated data and other information. In addition to the host environment, Small Computer System Interface (SCSI) controllers 206, serial interfaces 207, audio-visual subsystem 208 and desktop display cards 209 are also connected to the PCI bus 203.

The SCSI controllers 206 interface video storage devices 211 and audio storage devices 212. In the present embodiment, these storage devices are contained within the main system housing shown in FIG. 1 although, in alternative configurations, these devices may be housed externally.

Video storage devices 211 and audio storage devices 212 are configured to store compressed video and audio data, respectively. In one embodiment, video data is striped across the video storage devices 211, which are configured as a RAID subsystem. A similar arrangement is provided for the audio storage devices 212, which also is configured as a RAID subsystem. Sufficient bandwidth is provided, in terms of the video storage devices 211 and the SCSI controllers 206, to allow multiple video streams of data to flow over the PCI bus 203 in real-time. Although the video data is compressed, preferably using conventional JPEG or MPEG procedures, the data volume of video material is still relatively large compared to the data volume of the audio material. Thus, the audio storage devices 212 in combination with SCSI controllers 206 provide sufficient bandwidth for an even larger number of audio channels to be conveyed over the PCI bus 203 in real-time.

Serial interfaces 207 interface with control devices 102 and 103 via an input/output port 213, in addition to providing control instructions for video tape recorder 109 via a video interface port 214. The video interface port 214 also receives component video material from the audio-visual subsystem 208.

The audio-visual subsystem 208 may include commercially available video boards, such as the Matrox DigiSuite™ or the Truevision Targa™ boards, wherein the audio-visual subsystem 208 is configured to code and decode between uncompressed video and JPEG or MPEG compressed video at variable compression rates. A limited degree of signal processing is provided by subsystem 208, under the control of the CPUs 201/202 and audio output signals, in the form of a left channel and a right channel, are supplied to an audio output port 215. Television monitor 106 receives luminance and chrominance signals from subsystem 208 via a video monitor interface 216 and a composite video signal from subsystem 208 is supplied to the desktop display subsystem 209, via link 217.

Desktop display 209 includes two VDU driver cards operating in a dual monitor configuration, thereby making the resources of both cards available to the operating system, such that they are perceived as a single large desktop. The desktop drivers support video overlay, therefore video sequences from the audio-visual subsystem 208 may be included with the VDU displays in response to receiving the composite signal via link 217. Thus, VDU 104 is connected to VDU interface 218 with VDU 105 being connected to interface 219. However, in operation, the VDUs provide a common desktop window, allowing application windows to be arranged on the desktop in accordance with operator preferences.

### Bin Windows

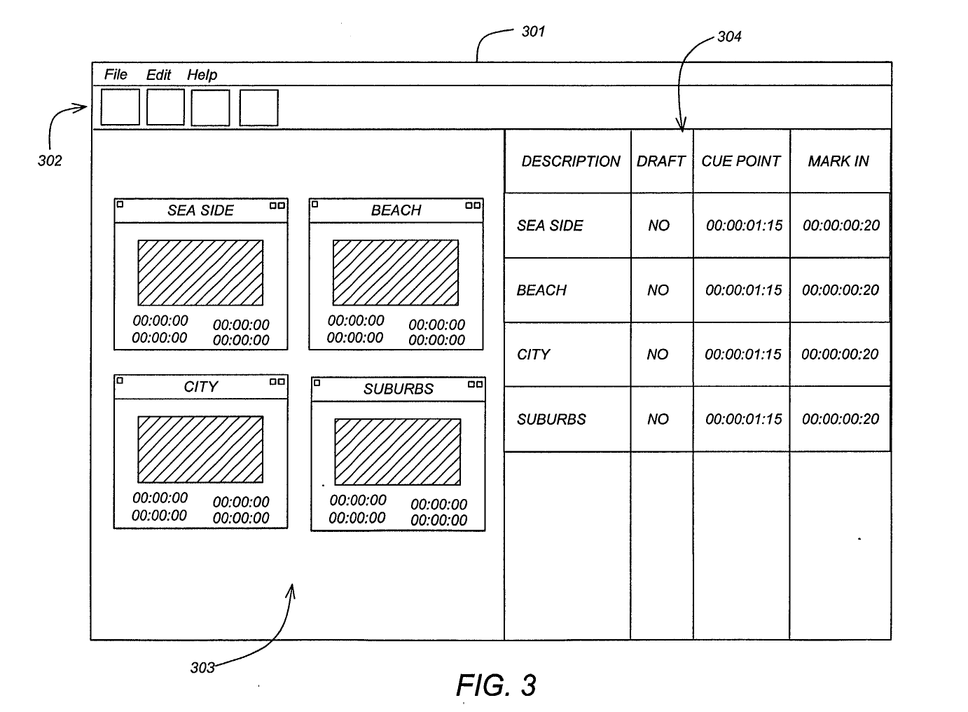

The editing suite shown in FIG. 1 facilitates the capture and management of data sources by displaying Bin windows 301 (also known as Bins) on monitor 104, as shown in FIG. 3. Bins 301 are the primary tool for organizing and managing source material. Bins 301 can be used to:

capture source materials for digitization;

import files and source materials;

search the database for source materials;

view and edit source material such as clips and images;

play and edit audio material;

delete material; and

other functions.

The Bin window 301 shown in FIG. 3 includes the following elements: (1) a Bin toolbar 302 for accessing commonly used Bin functions; (2) a Picon area 303 that contains any number of picons, which are visual representations of sources, such as a video, audio, images, graphics, and digital video effects; and (3) a Log area 304 that has a corresponding row of customizable source information for each picon in the Picon area 303. The Bin window 301 is used to manage source material that is then used to create one or more Timelines.

### Timelines

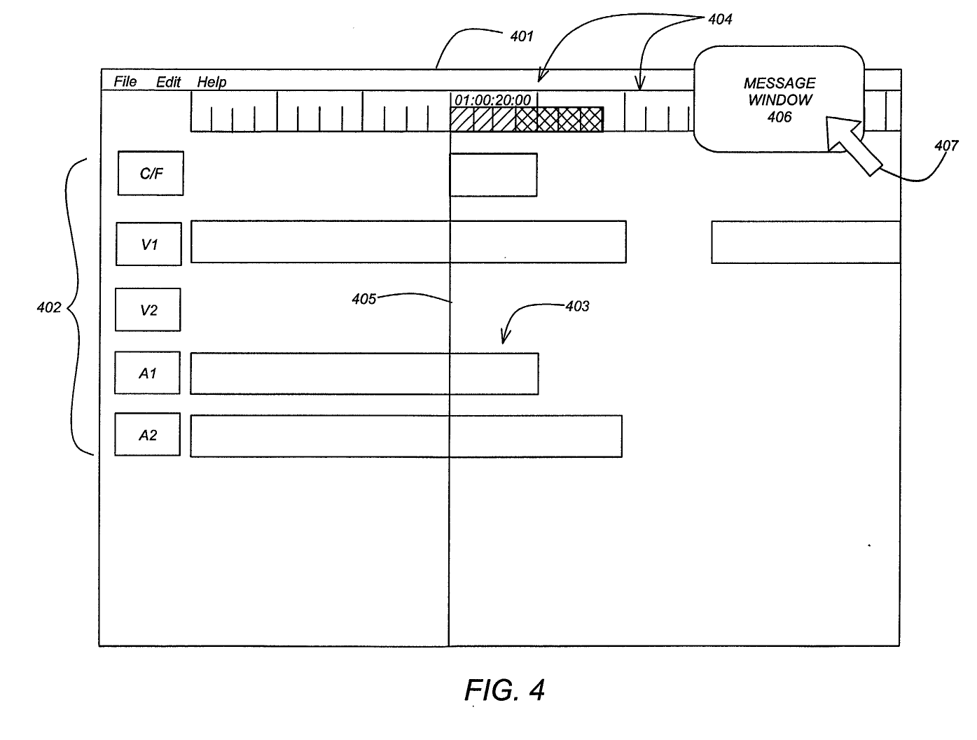

The editing suite shown in FIG. 1 facilitates editing of the digitized source material to create one or more output frames by displaying one or more Timelines 401 on monitor 104, as shown in FIG. 4. The operator builds result programs, i.e., output frames, using Timelines 401. The operator can have any number of Timelines 401 open and events in the Timeline 401 ate designed to provide the operator with all the relevant information required while working.

A Timeline 401 contains a plurality of edited source materials, such as video, audio, images, graphics and digital video effects (DVEs) sources. One or more tracks 402 on the Timeline 401 are used to separate, layer, and sequence sources in order to create the output frames. During editing, the operator places one or more events 403 on one or more tracks 402 of the Timeline, wherein an event 403 is usually some or all of a source, as denoted by an in point and an out point (in FIG. 4, each event 403 is represented by the rectangle on a track 402, wherein the left side of the rectangle represents an in point and the right side of the rectangle represents an out point). Thus, a Timeline 401 is made up of a sequence of tracks 402, and each of the tracks 402 is made up of a sequence of events 403 comprised of video, audio, images, graphics, and DVE source material.

In the example of FIG. 4, a scale bar 404 is shown at the top of the display representing a timecode for generated output frames comprised of a composite of the events 403 found on all the tracks 402. Individual output frames may be viewed and a particular output frame may be selected by means of a vertical position line 405. Thus, as output frames are being displayed, position line 405 traverses across the Timeline 401 from left to right.

The scale bar 404 may be enabled to show the approximate time code of the current frame in the Timeline 401 (i.e., at vertical position line 405). Provided the operator has zoomed in far enough on the scale bar 404 to show sufficient detail, the scale bar 404 may show the exact time code of the current frame in the Timeline 401. (The small tic marks show offsets for individual frames).

In addition, the operator can render arbitrary sections of the Timeline 401 at any time. Previously, it could be unclear what sections were tendered, whether the rendered material overlapped other rendered material, or whether the rendered material was enabled or disabled for display. In the preferred embodiment, shading on the scale bar 404 provides this information (in the example of FIG. 4, three patterns are used to illustrate shading, i.e., solid white, diagonal and cross-hatched).

For example, a diagonal scale bar 404 may indicate that rendered frames exist for the corresponding section of the Timeline 401, and that these frames are enabled for use. A solid white scale bar 404 may indicate that, while rendered frames exist for that section of the Timeline 401, they are currently disabled, and will not be used during playback, scrubbing, compositing, etc. As with the rest of the user interface, the particular colors or patterns used for shading on the scale bar 404 are selectable by the operator.

If multiple renders overlap, a cross-hatched time scale 404 may be used in the area of overlap between rendered frames. One embodiment of the present invention supports up to five different shades for overlapped material, i.e., if more than five renders overlap, the shade or pattern used for the scale bar 404 will be the same as for exactly five overlapping renders.

If multiple renders are adjacent or overlap, a separating line may be shown at the point where one render supercedes another. For example, the diagonal and cross-hatch areas of FIG. 4 may show that two tenders overlap, but if a separation line extends above the cross-hatch area to the right of the diagonal area, then the render for that cross-hatch area supercedes the diagonal area.

Although this scheme is useful for displaying a great deal of information in a compact format, not all the desired information is always visible. For example, there may be no shading color that shows when disabled rendered material overlaps enabled rendered material.

Consequently, the basic shading on the Timeline 401 scale bar may be augmented by a “tool tips” message window 406 that appear when a cursor 407 hovers over any of these areas. The message window 406 may show:

whether the operator is viewing and manipulating available video or audio renders,

how many rendered versions of the Timeline 401 material are available at the cursor 407 position,

whether a render has been disabled,

which particular render is used by default at the current cursor position,

the duration of each render,

the location in the Timeline 401 at which each render begins,

the date and time the render occurred,

the approximate size of the rendered file, and

whether the render includes a matte channel (for video sources).

For the purposes of this example, it is assumed that video, audio, images, graphics and DVE source material may be processed in real-time. Sources are identified in composite/filter source tracks, such as the track 402 labeled C/F, video source tracks 402, such as the tracks 402 labeled V1 and V2, and audio source tracks, such as the tracks 402 labeled A1 and A2. These sources are identified by a Timeline 401 and reference to the selected sources is included within the Timeline 401. For example, during the playing of video source material V1 as shown in FIG. 4, audio source material is being played from audio tracks A1 and A2, and composite/filter source track C/F is added.

In order to provide a coherent editing environment, edit points may be selected in the sources and timecodes are stored such that the required sources are read from their correct position when required in the output frames. Moreover, a number of different functions, such as mixes, cuts, wipes, fades, dissolves, etc., can be defined for multiple sources.

### Sub-Timelines

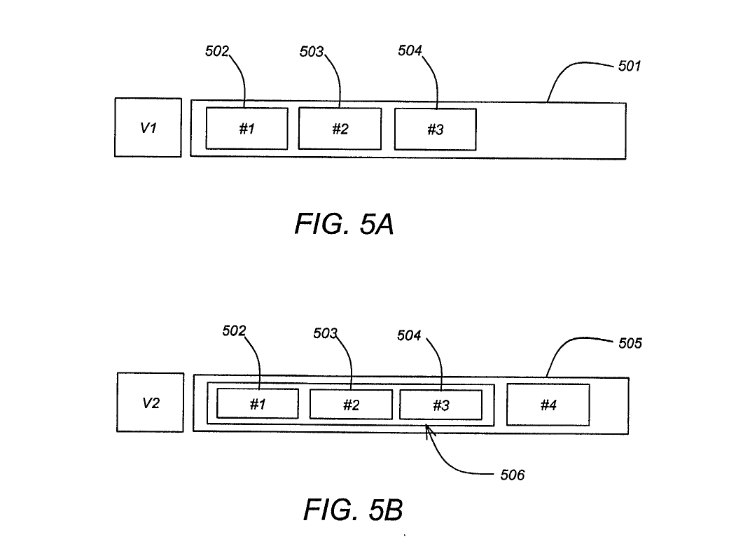

Events 403 on a Timeline 401 themselves may comprise Sub-Timelines, which are illustrated in FIGS. 5A and 5B. Sub-Timelines collapse a series of events 403 into a single container or source, called a nested source. A nested source is created by selecting one or more portions of a Timeline 401 with one or more tracks 402 and one or more events 403. Thereafter, the nested source is represented as a single event 403 on a single track 402 that can be added or edited to the same or another Timeline 401 for further compositing and have effects applied to it in the same way as any other source. The nested source can also be opened up at a later date reflecting the full track 402 layout of the original Timeline 401.

In the example of FIG. 5A, a Timeline 501 includes three discrete events 502, 503, and 504 (also labeled as #1, #2, and #3). These events 502, 503, and 504 can be edited and composited as desired. In the example of FIG. 5B, the events 502, 503, and 504 are moved to a Sub-Timeline 505, wherein the Timeline 501 contains only the nested source 506. The nested source 506 has the original events 502, 503, and 504 nested within it. The operator can edit, composite, and add effects to the nested source 506 as they would any other event. The operator can also move the nested source 506 to another Sub-Timeline, which would create another nested source, wherein the Timeline would contain two levels of nesting, which itself could be edited, composited, and effects added thereto.

Sub-Timelines are important where effects are layered on Timelines. This feature can be added to vertical stacking of events, to extend the multi-layer video effects that can be produced. Using Sub-Timelines, the operator works on a parent Timeline in context, with constant quick access to Sub-Timeline content, by just right-clicking the Sub-Timeline event and selecting Open Timeline to view its contents. Moreover, this functionality allows for complete interactive vertical compositing with full nesting and interactive layer support. An operator could theoretically have unlimited nested sources within nested sources, which could be used for creating very sophisticated results.

However, the nested source 506 always refers back to the original source material; if the original source material has changed, the nested source 506 is updated automatically. Nesting is used both to organize projects and to apply multiple layers of compositing effects. The operator can use Sub-Timelines to manage complex projects and Timeline renders.

Nested sources can be created in either of two ways: by creating a Sub-Timeline or by using a Drag icon. When nesting is performed using a Sub-Timeline, the original material is moved or copied into a Sub-Timeline and a nested source is created on the original or root Timeline. When nesting is performed using a Drag icon, a nested source is created in the Bin window which contains the contents of the original Timeline. However, the original material remains on the Timeline; it is not moved or copied to a Sub-Timeline.

### Compositing

Referring again to FIG. 4, compositing is essentially the blending of one or more layers of video, audio, images, graphics, and digital video effects sources, one on top of the other, in one or more tracks 402. Each track 402 of a Timeline 401 can act as a separate layer, and any empty or muted tracks 402 are transparent, showing through to the tracks 402 beneath. Compositing can consist of simply moving and resizing events 403, so that they are placed together in a frame. With Timeline-based effects such as real-time motion effects, color correction and animatable positioning and scaling, the operator can build multi-layer visual effects directly in the Timeline 401. Thus, an operator can build complex composites on multiple tracks 402 using transparencies, masks, alpha channels, scaling, and positioning, wherein each track 402 acts as a layer in the composite.

Vertical Compositing

Editing can be performed vertically in a Timeline 401 by applying effects directly to events 403 and compositing using transparency, alpha channels, scaling, and positioning, for example. As noted above, empty tracks 402 are transparent and show through to the tracks 402 beneath them.

Most visual effects the operator creates using these vertical effects tools are fully previewable in real time. As a result, they are easily monitored, modified, copied and pasted from event-to-event, or from Timeline-to-Timeline. Animated visual effects are customizable with thorough flexibility using a Keyframe Editor, which features graphic animation curve representation and intuitive, gestural keyframing.

Invisible Black Source

Building on the vertical compositing structure, black clips can be set to be invisible, so that an underlying track 402 is visible therethrough. This allows operators to build up sophisticated composites, as well as use the multi-track capability of the system for slipping and sliding events 403, or creating transition effects between tracks 402.

Event Based DVE Effects

Effects can be created directly on events 403 in the Timeline 401, and do not require the use of a DVE (digital video editing) track. This extends the system's vertical compositing capability beyond a previous two video track 402 limitation. The vertical compositing structure of the preferred embodiment allows operator to take advantage of all 99 video tracks 402 within a true vertical compositing environment.

Time Warp DVE Icon

A Time Warp DVE Icon can be applied to a video track 402 to adjust the speed of a video source residing on the track 402. The use of this icon results in a rendered, smooth, field blended, motion effect. Based upon cursor's position in time in a Keyframe Editor, a key-frame is added that adjusts the speed of the clip. This key-frame has all interpolation options. As a key-framed speed change will possibly result in not enough source material being available to fill the original duration of the clip, black will be substituted to replace the original source frames.

Multiple Layered Alpha Keyed Graphics

The Timeline 401 also supports automatic alpha keyed graphics. Within a single Timeline 401, operators can stack one or more graphics events 403 on one or more tracks 402, and the events 403 automatically key through. Additionally, these graphics support the full DVE effect pallet for animation and additional effect work. Transitions between the graphics, in addition to the effects, are supported as well.

Multiple Layered Traveling Mattes

Building on the alpha keyed graphics, the system supports traveling mattes as well. Operators can import one or more animations with traveling mattes, place the animations on one or more tracks 402, and the system will automatically key the mattes out. Additionally, the operator can scrub through these tracks 402 in real-time for fast and easy review of these composited results. Final playout requires rendering, but it is highly accelerated.

Real-time In-Context Interaction of All Composited Results.

All of the above features allow the operator to view their results through a real-time scrub. The operator does not have to render the results in order to see them. This gives the operators exceptional in context interaction with simple or sophisticated multi-layered composites.

Auto Assemble of Layered Composites.

The system implements sophisticated vertical compositing structures that allow for nested sources inside of any given Timeline 401. These composited results are automatically recreated through the project transfer between systems for automated off-line to on-line assembly work.

Sync Sources

Operators are able to take one or more video or audio sources, edit them to a Timeline 401, sync the audio with the video, select the synchronized video and audio, and then simply drag the selected video and audio into a Bin window 301 to create a new “sync source” from the selected video and audio. This sync source is editable to any other Timeline 401 and behaves as any natively captured sync source.

The result of creating sync sources in this manner is that they can be stored in the Bin window 301 and function as fully editable sources. These sources can be edited from the Bin window 301 or added directly to another Timeline 401. This gives operators exceptional flexibility in versioning, compositing, or creating complex programming with multiple sub-assembled versions.

A Source Viewer is used to view source clips and to prepare clips to record on a Timeline 401. The Source Viewer provides a variety of navigation tools for viewing source clips. Moreover, the Source Viewer can be used to add or update clips in the Bin window. After a clip is loaded into the Source Viewer, the in and out points can be marked or adjusted and thereafter the clip dragged back to the Bin window 301 to either add it as a new clip or to update an existing clip.

### Advanced Multi-Camera Feature

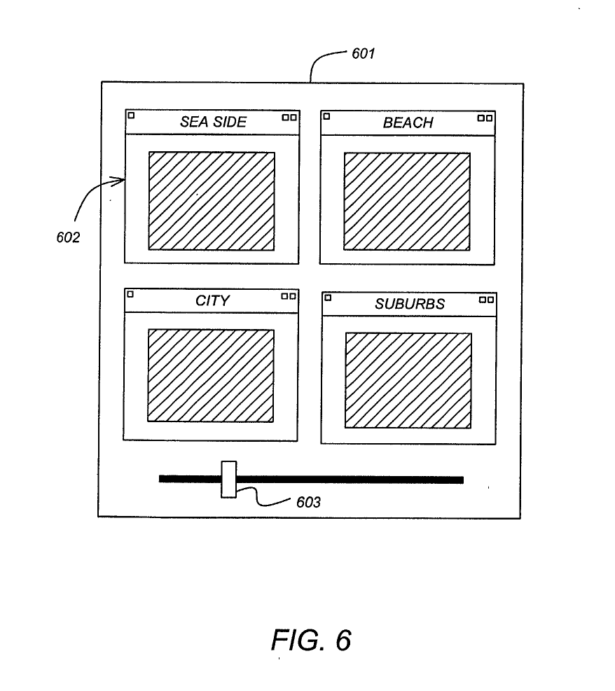

FIG. 6 illustrates a multi-cam feature provided in the compositing architecture according to the preferred embodiment of the present invention. The multicam feature is used for simultaneously viewing and editing multiple synced sources where each source has its own corresponding camera assignment. Specifically, a Source Viewer 601 can load up to nine synced sources 602 (i.e., video streams) without rendering, wherein each source 602 has its own corresponding camera assignment. In contrast, the hardware is only capable of playing two cameras.

The Source Viewer 601 is used to view multiple sources 602 simultaneously and to edit them to a Timeline 401. Two cameras are capable of real-time operation and updates at 30 frames per second. As more cameras are added, the system 101 will display the first two cameras for one frame and then leave their images on screen for the next frame (but not update them) and then display the other two cameras. This pattern repeats over time and each set of two cameras updates at 15 frames per second. This process can continue up to nine cameras with frames rates for all combinations as follows:

2 cameras—>30 fps

3 or 4 cameras—>15 fps

5 or 6 cameras—>10 fps

7 or 8 cameras—>7.5 fps

9 cameras—>6.0 fps

(Of course, other frame rates could be used as well.) In addition, a slider control 603 controls the display of all sources 602 simultaneously.

Using keyboard shortcuts while the sources 602 are played in the Source Viewer 601, the operator can switch between cameras without having to interrupt the record-to-Timeline operation, which allows on-the-fly camera-switching of multiple synced sources 602. Additional features allow for audio-follow-video, burn-in camera numbers for easy navigation between cameras during the editing process, and full control of all editing tools within the system during multi-camera playback.

### Media Export and Streaming Media Support

Once a result program is complete, the operator can perform a full-resolution print-to-tape function for broadcast delivery. However, with the growing demand for CD, DVD, and web-based delivery of video content, the operator can also use the Media Export function to output in one or more streaming formats for publishing the output frames to a network, such as the Internet or an intranet.

Using the Media Export function, the operator specifies formats and compression options according to their needs. The system outputs in multiple streaming formats, such as QuickTime™, Microsoft Windows Media™, MPEG 1-2, etc. In addition, the operator can also set up batch rendering sessions for multiple delivery formats, and preview the result before committing to the results.

The system also offers an integrated publishing solution that allows operators to create, author, publish and serve streaming media via the Internet or corporate Intranet. The system supplies a publishing page complete with integrated data base, wherein the publishing page may be integrated as a frame in any web site.

The functionality includes the following features:

Fully integrated asset management database.

Media asset management tool.

Integrated active server page scripts for dynamic presentation of media assets via Web pages.

Microsoft Media™ server for the streaming of files to clients.

The operator can set independent publishing locations for each job in the export queue. There is no need to post result render files manually, because the Media Export dialog integrates full web-publishing functionality. The operator can easily set up multiple web-delivery instances for publication to a web serving database. Each instance is published with a JPEG thumbnail, and is automatically made accessible from a customizable page for client review and editing.

### Recursive Method for Serialization of Hardware Accelerated Compositing Operations

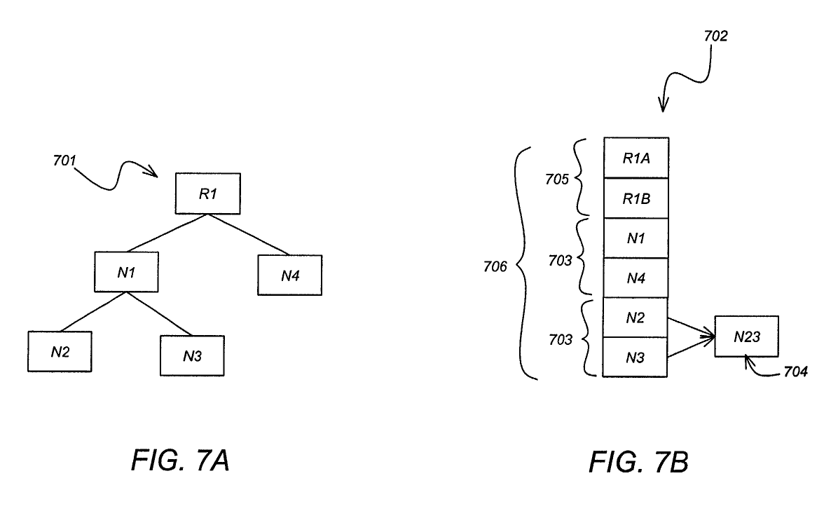

FIGS. 7A and 7B illustrate a recursive method for serialization of compositing operations performed by the preferred embodiment of the present invention. When effects in a Timeline imply compositing of one track on top of another, a tree of compositing operations 701 is generated, as shown in FIG. 7A, wherein the tree of compositing operations is comprised of a plurality of nodes, and each of the nodes comprises a compositing operation. A recursive function is used to visit each node (which represents an effect or frame of source material) to determine what each is, in turn, composed of. However, the present invention provides some new methods in this regard:

Compositing operations are broken up into one or more work units known as streaming headers 702, as shown in FIG. 7B, wherein the streaming headers closely match the resources available on the hardware device that performs the rendering operations.

The tree of compositing operations is recursed (recursively traversed) to generate pairs of streaming headers, wherein the pairs of streaming headers comprise a packet.

The recursion reduces the time required for rendering by examining each pair 703 of streaming headers 702 that is generated from a recursion of the tree 701. In many cases, based on the hardware resources required by a given pair 703 of streaming headers 702, the work of both can be merged into a single header 704. In other cases, new compositing operations 705 can be generated that result in the same visual outcome as the streaming header pair 703. In either case, the total number of streaming headers 702 and time required to render them is reduced.

The method limits the recursion based on hardware resources that are known to be available. For example, between nodes of the tree 701, each intermediate result must be stored in a buffer, only a limited number of which are available. The shape of the tree 701 and order of processing determine the number of temporary buffers required. The method attempts to optimize use of intermediate buffers by processing nodes of the tree 701 in an order that will free intermediate buffers for further use after as few steps as possible.

Optionally, the method will search at each node of the tree 701 for rendered material that can represent the sub-tree of material at that point.

At execution time, a streaming header 702 contains data pointers which reference video and graphic data at whatever memory location the buffering engine happens to use at the time. These pointers are volatile, in that they can vary each time the sequence of streaming headers 702 for a particular composite effect are executed. So, at build time, the streaming header 702 is divided into different sections. One section contains the actual hardware parameters that will be needed during execution, and another section contains information about the video and graphic material required for that header 702 that the buffering engine will fill in with volatile pointers later. In this way, all the effects data can be generated well prior to the time-constrained buffering activity, and for a particular packet 706 of streaming headers 702, hashing values can be generated that are constant, independent of the buffer locations of the video and graphic material used by the packet 706.

### Coarse Grain Invalidation of Cached Hierarchically Composited Images

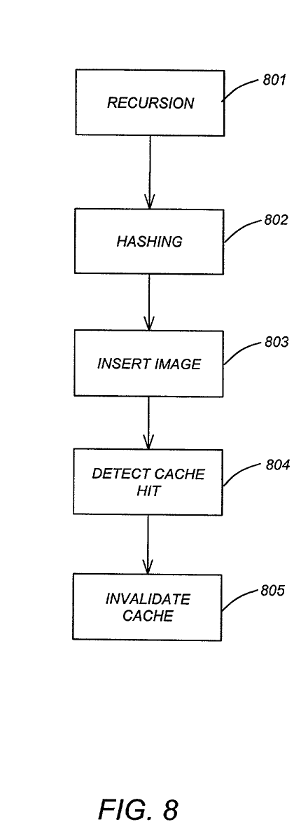

FIG. 8 illustrates a coarse grain invalidation method performed for cached hierarchically composited images according to the preferred embodiment of the present invention. Traditionally, when a cache contains images formed from a tree 701 of compositing operations, a detailed dependency graph must be maintained so that when a change is made, certain elements in the cache can be invalidated. However, when there is a loose association between the compositing tree 701 and the images in the cache (that is, there is no direct way to trace from the material that has changed to find all the images that need to be invalidated), then each image in the cache must be examined to determine whether it needs to be invalidated.

Such a cache exists in the present invention. Since the still image cache in the system 101 is used only to speed display of representative images (picons) in the visual display of the Timeline 401 and Bin 301, the cache is relatively small relative to the total number of frames of material stored in the system 101, so the entire cache can be searched each time an invalidation request is made, and it is not a problem for invalidation to occur at a coarse level. Coarse invalidation means that any image that involves a particular clip of source material can be invalidated, whether or not the particular frames are actually used in the composite image that is invalidated.

The following method is used to accomplish coarse invalidation of the cache:

1. The recursive function discussed above serializes the compositing tree 701 for a particular image that needs to be loaded into the cache, into an ordered packet 706 of streaming headers 702 (Block 801).

2. A hashing function is performed on the packet 706 to crate a hash value (Block 802). The hashing function is based on the cyclic redundancy check algorithm and the values are so highly randomized that it is highly unlikely that two different packets 706 contained in the cache will generate the same hash value.

3. An image entry is inserted in to the cache (Block 803). The cache retains the following information with each image entry: the hash value, the root clip ID, and a simple list of all other clip IDs encountered during the building of the packet 706. The list is built in such a way as to omit duplicate clip references.

4. A cache hit can be detected simply by comparing hash values of a given header packet 706 with the hash values in the cache (Block 804). On a cache miss, the header packet 706 contains everything needed to build the requested image and it is passed off to a rendering function. On a cache hit, the cached image is simply retrieved.

5. When a clip is modified, the cache can be invalidated at a coarse grain level by examining each item stored in the cache (Block 805). If the root clip ID matches, then the entry will be invalidated. If the root clip ID does not match, but the clip ID is found on the simple dependency list, then that entry is invalidated and an invalidation command is launched with the root clip ID as well. In this way, each image in the cache that contains a contribution, however indirect, of the modified clip will be properly invalidated. Note that it is not necessary to invalidate every other clip referenced in the list, but only the root clip ID. If any of the other clips do need to be invalidated, then they will themselves have a toot clip entry somewhere in the cache, and so they will be properly invalidated.

The described method is much more efficient for its purpose than storing and comparing entire header packets 706 in the cache, retaining complex fine grain dependency data in the cache, or maintaining bottom-up dependency tracking that links into the cache from outside.

### Persistent and Transient Hashing of Hierarchical Hardware Rendering Instructions

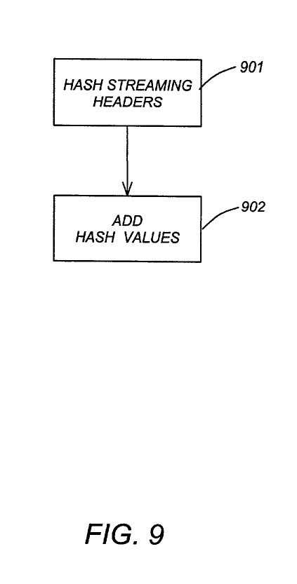

FIG. 9 illustrates a persistent and transient hashing method performed for hierarchical rendering instructions according to the preferred embodiment of the present invention. As described above, the streaming header packet 706 scheme can be and is hashed in a way that is independent of the actual buffer locations occupied by the video and graphic material used by the packet 706. However, any hash value generated as described is valid only during a particular runtime session, since the description of the composing media stored in each streaming header 702 references only runtime ordinals that can in turn be dereferenced to obtain a full description of the media.

This is by design, so that the header packets 706 are more compact, not duplicating information about the media that can be collected into a single location. Also, runtime ordinals can be de-referenced quickly so there is no degradation in performance.

In some cases, however, a hash value must be generated which is persistent from runtime to runtime. For example, when a transition effect is rendered, and the images involved each are described by a hash, that hash must be persistent so that next time the application is run, the rendered transition will be loaded from persistent storage and appear at the proper place.

In this case, when a persistent hash is required for the header packet 706, the method hashes each constituent streaming header 702 (Block 901), and then adds the results therefrom (902). In this method, each runtime ordinal is replaced by either a persistent ordinal in cases in which the application maintains mapping tables between runtime and persistent ordinals, or a hash of the persistent description of the media resource. The result cascaded hash value for the streaming header packet 706 involves only contributions from persistent media descriptions, so it is itself valid as a persistent hash value.

### A Method for Color Space Conversion and Luma Keying Using Hardware Designed for Resizing

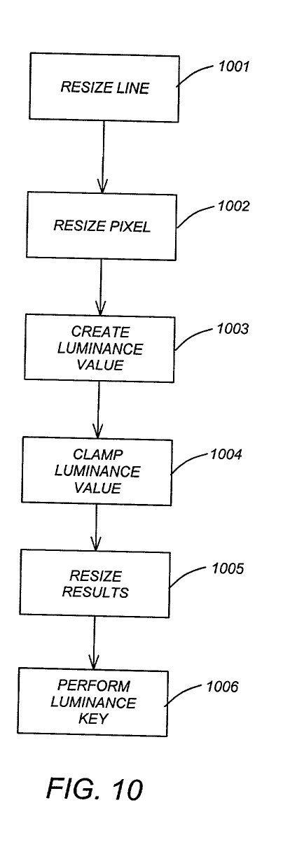

FIG. 10 illustrates a method for color space conversion and luma keying performed using hardware designed for resizing according to the preferred embodiment of the present invention. As noted above, the audio-visual subsystem 208 may include commercially available video boards, such as the Truevision Targa™ boards. The HUB-2 chip on the Targa™ board includes a 2D resizer and a two stage alpha compositor with simple ALU (arithmetic logic unit) functionality that operates on 32 bit αRGB pixels. There is no color space converter or luminance keying hardware on the board, and thus the following method was developed to provide these functions.

Normally, the alpha compositor blends each pixel channel in parallel, i.e., alpha with alpha, red with red, green with green, and blue with blue. There is no way to blend the red portion of a pixel directly with the green portion of a pixel, for example, such as would be required during color space conversion. But, there is a function to read alpha information from an 8 bit alpha buffer and supply it to the compositor. Using this function on a buffer that actually contains 32 bit pixel information, and wiring the normal 32 bit pixel sources to constant values, gives the alpha compositor the ability to read in one 32 bit αRGB pixel and generate four 32 bit output pixels with the contents: αααα, RRRR, GGGG, BBBB from the original pixel. Now, the different color components of the image can be selected and blended together using the resizer.

The present invention selects a line of an image for processing (Block 1001) to reduce the amount of temporary space required by this process to four times a single line size. The hardware resizer is a two dimensional resizer, that includes a high bit depth line buffer to accumulate weighted pixels for smooth blending in the vertical dimension. A pixel of the selected line is then selected for processing (Block 1002), which can be performed by resizing without smoothing (that is, resizing with decimation) in the horizontal dimension by selecting a scaling factor of four to one. For example, selecting only red components can be performed by setting the resizer input pointing to the first RRRR pixel in the line, and setting the horizontal resizer to decimate input pixels 4 to 1. The resizer will read the entire line of αααα, RRRR, GGGG, BBBB pixels, but pass only the RRRR components to the vertical resizer.

Color space conversion can be done by programming the vertical resizer to blend smoothly the incoming horizontal lines using blending coefficients different from what would normally be used for a resize. For example, a vertical resize by 3 to 1 would normally weight each line coming into the vertical resizer by one third. But, to generate luminance values, the horizontal resizer is set to select first a line of RRRR pixels, then a line of GGGG pixels, then a line of BBBB pixels, and the vertical resizer is set to apply blending coefficients of 0.299, 0.587, and 0.114, respectively, to each of the three input lines. The result is a line of YYYY pixels, where Y is the luminance component generated for the selected pixel (Block 1003).

Notice that the Y component also appears in the alpha channel of the 32 bit result pixel. This means that the result image may immediately be used as a matte source for keying another image (whether an image with unrelated content or an RGB version of the original image). To achieve luminance keying, a threshold level must be set in the alpha channel, so that alpha values below a certain level have the zero effect, and above the threshold have full effect. Also, some linearly interpolated values from 0 or 255 in a few alpha pixels near the threshold allow the luminance keying threshold to be softened.

To accomplish this, the Y pixels in the alpha component are processed using the given keying threshold (T, the Y value at which the edge begins to have a non-zero contribution to the key) and softness (S, the number of Y pixels of softness at the edge) in the following way. To clamp all Y pixel values below T to zero (Block 1004), a pass through the alpha compositor is made, subtracting constant T from all input pixels with clamping turned on in the compositor. This result is then passed through the resizer (Block 1005), resizing 1 line to 1 line, but with a weighting coefficient of 255/(S+1). This large gain scales only S pixels into the 0 to 255 softness range. The pixels with Y values below T, previously set to zero will still be zero, while the values above T+S will be clamped to 255 at the output of the resizer. The resulting pixels can then be applied as a regular alpha channel along with an original copy of the RGB image to perform the luminance key (Block 1006).

### Conclusion

This concludes the description of the preferred embodiment of the invention. The following describes some alternative embodiments for accomplishing the present invention. For example, any type of computer or combination of computers, such as a mainframes, minicomputers, work stations, personal computers, and networked versions of the same, could be used with the present invention. In addition, any program, function, or system providing audio-visual editing functions could benefit from the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A non-linear digital video editing system, comprising:
(a) a computer system, including one or more monitors, operator input devices, and data storage devices, wherein digitized source material is stored on the data storage devices and displayed on the monitors in response to operator commands received via the input devices; and
(b) video editing software, executed by the computer system, for editing the digitized source material to create a sequence of one or more output frames, wherein the video editing software displays one or more timelines on the monitor, each timeline contains one or more tracks that separate, layer, and sequence sources, including video, audio, graphics and digital video effects sources, an operator places one or more events on one or more of the tracks in order to create the output frames, and one or more of the events comprise one or more nested sources.

2. The non-linear digital video-editing system of claim 1, wherein a time scale indicates whether portions of the sources are tendered.

3. The non-linear digital video-editing system of claim 1, wherein each of the nested sources comprise a sub-timeline.

4. The non-linear digital video-editing system of claim 1, wherein the video editing software creates a nested source by selecting one or more portions of a timeline.

5. The non-linear digital video-editing system of claim 1, wherein the video editing software represents the nested source as a single event on a single track that is edited to a timeline.

6. A non-linear digital video editing system, comprising:
(a) a computer system, including one or more monitors, operator input devices, and data storage devices, wherein digitized source material is stored on the data storage devices and displayed on the monitors in response to operator commands received via the input devices; and
(b) video editing software, executed by the computer system, for editing the digitized source material to create a sequence of one or more output frames, wherein the video editing software displays one or more timelines on the monitor, each timeline contains one or more tracks that separate, layer, and sequence sources, including video, audio, graphics and digital video effects sources, an operator places one or more events on one or more of the tracks in order to create the output frames, and the video editing software performs vertical compositing by blending one or more layers of sources, one on top of the other, in one or more of the tracks.

7. The non-linear digital video-editing system of claim 6, wherein each track of a timeline acts as a separate layer, and any empty or muted tracks are transparent, showing through to the tracks beneath.

8. The non-linear digital video-editing system of claim 6, wherein black sources are invisible, so that an underlying track is visible therethrough.

9. The non-linear digital video-editing system of claim 6, wherein the video editing software applies a time warp icon to a track to adjust a speed of a video source residing on the track.

10. The nonlinear digital video-editing system of claim 6, wherein the video editing software includes automatic alpha keyed graphics, such that one or more graphic sources are stacked on one or more tracks and then automatically keyed through the tracks.

11. The non-linear digital video-editing system of claim 6, wherein the video editing software imports one or more animations with traveling mattes onto one or more tracks, and automatically keys the mattes out.

12. A non-linear digital video editing system, comprising:
(a) a computer system, including one or more monitors, operator input devices, and data storage devices, wherein digitized source material is stored on the data storage devices and displayed on the monitors in response to operator commands received via the input devices; and
(b) video editing software, executed by the computer system, for editing the digitized source material to create a sequence of one or more output frames, wherein the video editing software displays one or more timelines on the monitor, each timeline contains one or more tracks that separate, layer, and sequence sources, including video, audio, graphics and digital video effects sources, an operator places one or more events on one or more of the tracks in order to create the output frames, and the video editing software synchronizes one or more video and audio sources, selects the synchronized video and audio sources, and then creates a sync source from the selected video and audio sources.

13. A non-linear digital video editing system, comprising:
(a) a computer system, including one or more monitors, operator input devices, and data storage devices, wherein digitized source material is stored on the data storage devices and displayed on the monitors in response to operator commands received via the input devices; and
(b) video editing software, executed by the computer system, for editing the digitized source material to create a sequence of one or more output frames, wherein the video editing software displays one or more timelines on the monitor, each timeline contains one or more tracks that separate, layer, and sequence sources, including video, audio, graphics and digital video effects sources, an operator places one or more events on one or more of the tracks in order to create the output frames, and the video editing software includes a multi-cam feature for simultaneously viewing and editing multiple synced sources, wherein each source has its own corresponding camera assignment.

14. A non-linear digital video editing system, comprising:
(a) a computer system, including one or more monitors, operator input devices, and data storage devices, wherein digitized source material is stored on the data storage devices and displayed on the monitors in response to operator commands received via the input devices; and
(b) video editing software, executed by the computer system, for editing the digitized source material to create a sequence of one or more output frames, wherein the video editing software displays one or more timelines on the monitor, each timeline contains one or more tracks that separate, layer, and sequence sources, including video, audio, graphics and digital video effects sources, an operator places one or more events on one or more of the tracks in order to create the output frames, and the video editing software uses a media export function to output in one or more streaming formats for publishing the output frames to a network.

15. A method for serialization of compositing instructions in a non-linear video editing system, comprising:
(a) generating a tree of compositing operations comprised of a plurality of nodes, wherein each of the nodes comprises a compositing operation;
(b) breaking up the compositing operations into one or more streaming headers, wherein the streaming headers match resources available on a hardware device that performs rendering operations;
(c) recursing the tree of compositing operations to generate pairs of streaming headers, wherein the pairs of streaming headers comprise a packet;
(d) reducing a time required for rendering by examining each pair of streaming headers that is generated from a recursion of the tree;

16. The method for serialization of claim 15, wherein the reducing step comprises merging a pair of streaming headers into a single header.

17. The method for serialization of claim 15, wherein the reducing step comprises generating a new compositing operation for a pair of streaming headers.

18. The method for serialization of claim 15, wherein the streaming header contains data pointers which reference video and graphic data.

19. The method for serialization of claim 15, wherein the streaming header is divided into a section containing actual hardware parameters needed during execution, and a section containing information about the video and graphic material required for the header.

20. A method for invalidating cached hierarchically composited images, comprising:
(a) serializing a compositing tree for a particular image that needs to be loaded into the cache, into an ordered packet of streaming headers;
(b) performing a hashing function on the packet to create a hash value;
(c) insetting an image entry into the cache according to the hash value;
(d) detecting one or more cache hits by comparing the hash values of a given header packet with the hash values in the cache; and
(e) invalidating the cache at a coarse grain level by examining each item stored in the cache, when a clip is modified.

21. A method for color space conversion and luma keying, comprising:
(a) selecting a line of an image;
(b) selecting a pixel of the selected line;
(c) generating a luminance component of the selected pixel;
(d) clamping the generated luminance component;
(e) resizing the clamped luminance component;
(f) performing a luminance key on the resized luminance component.
